(19) United States
(12) Patent Application Publication
(10) Pub. No.: US 2010/0170648 A1
(43) Pub. Date: Jul. 8, 2010

(54) USE OF AN AQUEOUS POLYMER COMPOSITION FOR IMPREGNATING RAW PAPER

(76) Inventors: Oihana Elizalde, Mannheim (DE); Matthias Gerst, Neustadt (DE)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/160,683

(22) PCT Filed: Jan. 9, 2007
(86) PCT No.: PCT/EP2007/050185

§ 371 Date: Jul. 11, 2008

(30) Foreign Application Priority Data
Jan. 13, 2006 (DE) 102006001979.2

(51) Int. Cl. D21H 19/10; C08L 33/02; C08F 2/22; B05D 3/02

(52) U.S. Cl. 162/135; 524/522; 524/460; 427/391

(57) ABSTRACT

Use of an aqueous polymer composition for impregnating base paper.

The present invention relates to the use of an aqueous polymer composition for impregnating base paper, the aqueous polymer composition being obtainable by free radical emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
b) from 0 to 20% by weight of at least one further ethylenically unsaturated monomer which differs from the monomers A1 [monomers A2], incorporated in the form of polymerized units,
   and the monomer mixture M being composed of
i) from 0.01 to 10% by weight of at least one ethylenically unsaturated monomer M1 which comprises at least one epoxide group and/or at least one hydroxyalkyl group, and
from 90 to 99.99% by weight of at least one further ethylenically unsaturated monomer M2 which differs from the monomers M1.

The present invention also relates to the aqueous polymer composition itself, a process for impregnating base paper and the impregnated base paper and the use thereof for the production of decorative paper.

Particleboards are often laminated with decorative sheets and are used in this form for the production of pieces of furniture. Decorative sheets substantially comprise an impregnated base paper which is printed with a printing ink and therefore has the desired appearance and is generally coated with a protective coating, for example an electron beam-curable finish.

The performance characteristics of the decorative paper are determined substantially by the impregnated base paper. The impregnation of the base paper should in particular increase the strength of the base paper and should result in good compatibility with the printing ink and the protective coating and in particular good cohesion of the layers in the decorative paper.

EP-A 889 168 and EP-A 223 922 disclose the impregnation of base paper with aqueous polymer dispersions.

Emulsion polymers which comprise small amounts of acrylic acid and methylolmethacrylamide are commercially available as binders for this application (e.g. Acronal® S 305 D).

In the case of the impregnated base papers known to date, the performance characteristics of the decorative papers produced therefrom are often still unsatisfactory. Furthermore, the impregnated base papers known to date have an undesired tendency to yellowing on drying at elevated temperature.

EP-A 445 578, EP-A 583 086 and EP-A 882 074 describe aqueous solutions of polycarboxylic acids and polyols. The impregnation of base papers is not described in these publications.

It was an object of the present invention to provide a process for impregnating base paper by means of an aqueous polymer composition, which process gives an impregnated base paper which does not have the disadvantages of impregnated base paper of the prior art, in particular the tendency thereof to yellowing.

Accordingly, the process defined at the outset was found.

According to the invention, an aqueous polymer composition is used which is obtainable by free radical emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
b) from 0 to 20% by weight of at least one further ethylenically unsaturated monomer which differs from the monomers A1 [monomers A2], incorporated in the form of polymerized units,
   and the monomer mixture M being composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1.

The procedure for free radical emulsion polymerizations of ethylenically unsaturated monomers in an aqueous medium has been widely described in the past and is therefore sufficiently well known to the person skilled in the art [cf. in this context emulsion polymerization in Encyclopedia of Polymer Science and Engineering, Vol. 8, page 659 et seq. (1987); D. C. Blackley, in High Polymer Latices, Vol. 1, page 35 et seq. (1966); H. Warson, The Applications of Synthetic Resin Emulsions, Chapter 5, page 246 et seq. (1972); D. Diederich, Chemie in unserer Zeit 24, pages 135 to 142 (1990); Emulsion Polymerisation, Interscience Publishers, New York (1965); DE-A 40 03 422 and Dispersionen synthetischer Hochpolymerer, F. Hölscher, Springer-Verlag, Berlin (1969)]. The free radical aqueous emulsion polymerization reaction is usually effected in such a way that the ethylenically unsaturated monomers are dispersed with the concomitant use of dispersants in an aqueous medium and in the form of monomer droplets and are polymerized by means of a free radical polymerization initiator. The preparation of the aqueous polymer composition present according to the invention differs from the known prior art in that a specific monomer mixture M is subjected to free radical polymerization in the presence of a specific polymer A.

According to the invention, a polymer A is used which is composed of
a) from 80 to 100% by weight of at least one ethylenically unsaturated mono- and/or dicarboxylic acid [monomers A1] and
b) from 0 to 20% by weight of at least one further ethylenically unsaturated monomer which differs from the monomers A1 [monomers A2],
   incorporated in the form of polymerized units.

Suitable monomers A1 are in particular α,β-monoethylenically unsaturated mono- and dicarboxylic acids which have 3 to 6 carbon atoms, possible anhydrides thereof and water-soluble salts thereof, in particular alkali metal salts thereof, such as, for example, acrylic acid or methacrylic acid, maleic acid, fumaric acid, itaconic acid, citraconic acid, tetrahydrophthalic acid and the anhydrides thereof, such as, for example, maleic anhydride, and the sodium or potassium salts of the abovementioned acids. Acrylic acid, methacrylic acid and/or maleic anhydride are particularly preferred, acrylic acid being especially preferred.

For the preparation of the polymer A used according to the invention, in particular ethylenically unsaturated compounds which can be subjected to free radical copolymerization with monomer A1 in a simple manner are suitable as at least one monomer A2, such as, for example, ethylene, vinyl aromatic monomers, such as styrene, α-methyl styrene, o-chlorostyrene or vinyltoluenes, vinyl halides, such as vinyl chloride or vinylidene chloride, esters of vinyl alcohol and monocarboxylic acids having 1 to 18 carbon atoms, such as vinyl acetate, vinyl propionate, vinyl n-butyrate, vinyl laurate and vinyl stearate, esters of α,β-monoethylenically unsaturated mono- and dicarboxylic acids having preferably 3 to 6 carbon atoms, such as, in particular, acrylic acid, methacrylic acid, maleic acid, fumaric acid and itaconic acid, with alkanols having in general 1 to 12, preferably 1 to 8 and in particular 1 to 4 carbon atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate, nitriles of α,β-monoethylenically unsaturated carboxylic acids, such as acrylonitrile, methacrylonitrile, fumarodinitrile, maleodinitrile, and C₄₋₈-conjugated dienes, such as 1,3-butadiene (butadiene) and isoprene. Said monomers are as a rule the main monomers which, based on the total amount of monomers A2, together account for a proportion of ≧50% by weight, preferably ≧80% by weight and particularly preferably ≧90% by weight or even constitute the total amount of the monomers A2. As a rule, these monomers have only a moderate to low solubility in water under standard temperature and pressure conditions [20° C., 1 atm (absolute)].

Monomers A2 which have a high water solubility under the abovementioned conditions are those which comprise either at least one sulfo group and/or the corresponding anion thereof or at least one amino, amido, ureido or N-heterocyclic group and/or the ammonium derivatives thereof which are alkylated or protonated under nitrogen. Acrylamide and methacrylamide and furthermore vinylsulfonic acid, 2-acrylamido-2-methylpropanesulfonic acid, styrenesulfonic acid and the water-soluble salts thereof and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate may be mentioned by way of example. Usually, the abovementioned water-soluble monomers A2 are present only as modifying monomers in amounts of ≦10% by weight, preferably ≦5% by weight and particularly preferably ≦3% by weight, based on the total amount of monomers A2.

Monomers A2, which usually increase the internal strength of the films of a polymer matrix, usually have at least one epoxy, hydroxyl, N-methylol or carbonyl group or at least two nonconjugated ethylenically unsaturated double bonds. Examples of these are monomers having two vinyl radicals, monomers having two vinylidene radicals and monomers having two alkenyl radicals. Particularly advantageous are the diesters of dihydric alcohols with α,β-monoethylenically unsaturated monocarboxylic acids, among which acrylic and methacrylic acid are preferred. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinyl benzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular importance in this context are C₁-C₈-hydroxyalkyl methacrylates and acrylates, such as n-hydroxyethyl, n-hydroxypropyl or n-hydroxybutyl acrylate and methacrylate, and compounds such as diacetoneacrylamide and acetylacetoxyethyl acrylate or methacrylate. Frequently, the above-mentioned crosslinking monomers A2 are used in amounts of ≦10% by weight, but preferably in amounts of ≦5.5% by weight, based in each case on the total amount of monomers A2. Particularly preferably however, no such crosslinking monomers A2 at all are used for the preparation of the polymer A.

Advantageously, monomer mixtures which comprise
from 50 to 100% by weight of esters of acrylic and/or methacrylic acid with alkanols having 1 to 12 carbon atoms, or
from 50 to 100% by weight of styrene and/or butadiene, or
from 50 to 100% by weight of vinyl chloride and/or vinylidene chloride, or
from 40 to 100% by weight of vinyl acetate, vinyl propionate and/or ethylene
   are used as monomers A2 for the preparation of the polymer A.

According to the invention, the polymerized proportion of monomers A2 in the polymer A is advantageously ≦10% by weight or ≦5% by weight. Particularly advantageously, the polymer A comprises no monomers A2 at all incorporated in the form of polymerized units.

The preparation of polymers A is familiar to the person skilled in the art and is effected in particular by free radical solution polymerization, for example in water or in an organic solvent (cf. for example A. Echte, Handbuch der Technischen Polymerchemie, chapter 6, VCH, Weinheim, 1993 or B. Vollmert, Grundriss der Makromolekularen Chemie, volume 1, E. Vollmert Verlag, Karlsruhe, 1988).

Polymer A advantageously has a weight average molecular weight of ≧1000 g/mol and ≦100 000 g/mol. It is advantageous if the weight average molecular weight of polymer A is ≦50 000 g/mol or ≦30 000 g/mol. Particularly advantageously, polymer A has a weight average molecular weight of ≧3000 g/mol and ≦20 000 g/mol. Establishing the weight average molecular weight during the preparation of polymer A is familiar to the person skilled in the art and is advantageously effected by free radical aqueous solution polymerization in the presence of free radical chain-transfer compounds, the so-called free radical chain-transfer agents. The determination of the weight average molecular weight is also familiar to the person skilled in the art and is effected, for example, by means of gel permeation chromatography.

According to the invention, it is possible in the preparation of the aqueous polymer composition, if appropriate, initially to take a portion or the total amount of polymer A in the polymerization vessel. However, it is also possible to meter in the total amount or any remaining residual amount of polymer A during the polymerization reaction. The total amount or any remaining residual amount of polymer A can be metered into the polymerization vessel batchwise in one or more portions or continuously with constant or variable flow rates. Particularly advantageously, at least one portion of polymer A is initially taken before initiating the polymerization reaction in the polymerization vessel.

For the preparation of the aqueous polymer composition, it is unimportant whether polymer A is prepared in situ before the polymerization of the monomer mixture M in the polymerization vessel or is used directly as a commercially available or separately prepared polymer.

In the process according to the invention for the preparation of the aqueous polymer composition, dispersants which keep both the monomer droplets and the polymer particles obtained by the free radical polymerization dispersed in the aqueous phase and thus ensure the stability of the aqueous polymer composition produced are frequently concomitantly used. Both the protective colloids usually used for carrying out aqueous free radical emulsion polymerizations and emulsifiers are suitable as such.

Suitable protective colloids are, for example, polyvinyl alcohols, cellulose derivatives or copolymers comprising vinylpyrrolidone. A detailed description of further suitable protective colloids is to be found in Houben-Weyl, Methoden der organischen Chemie, volume XIV/1, Makromolekulare Stoffe, pages 411 to 420, Georg-Thieme-Verlag, Stuttgart, 1961. Since the polymer A used according to the invention can also act as a protective colloid, advantageously no additional protective colloids are used according to the invention.

Of course, mixtures of emulsifiers and/or protective colloids may also be used. Frequently, exclusively emulsifiers whose relative molecular weight, in contrast to the protective colloids, is usually below 1000 are used as dispersants. They may be either anionic, cationic or nonionic. Of course in the case of the use of mixtures of surface-active substances, the individual components must be compatible with one another, which in case of doubt can be checked by means of a few preliminary experiments. In general, anionic emulsifiers are compatible with one another and with nonionic emulsifiers. The same also applies to cationic emulsifiers, whereas anionic and cationic emulsifiers are generally not compatible with one another.

Customary emulsifiers are, for example, ethoxylated mono-, di- and trialkylphenols (degree of ethoxylation: 3 to 50, alkyl radical: C₄ to C₁₂), ethoxylated fatty alcohols (degree of ethoxylation: 3 to 50; alkyl radical: C₈ to C₃₆) and alkali metal and ammonium salts of alkyl sulfates (alkyl radical: C₈ to C₁₂), or sulfuric monoesters of ethoxylated alkanols (degree of ethoxylation: 3 to 30, alkyl radical: C₁₂ to C₁₈) and ethoxylated alkylphenols (degree of ethoxylation: 3 to 50, alkyl radical: C₄ to C₁₂), of alkanesulfonic acids (alkyl radical: C₁₂ to C₁₈) and of alkylarylsulfonic acids (alkyl radical: C₉ to C₁₈). Further suitable emulsifiers are to be found in Houben-Weyl, Methoden der organischen Chemie, volume XIV/1, Makromolekulare Stoffe, pages 192 to 208, Georg-Thieme-Verlag, Stuttgart, 1961.

Compounds of the general formula I

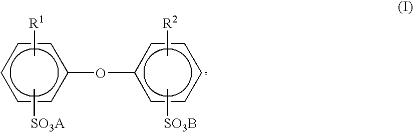

where R¹ and R² are C₄- to C₂₄-alkyl and one of the radicals R¹ or R² may also be hydrogen, and A and B may be alkali metal ions and/or ammonium ions, have furthermore proven suitable as surface-active substances. In the general formula I, R¹ and R² are preferably linear or branched alkyl radicals having 6 to 18 carbon atoms, in particular having 6, 12 or 16 carbon atoms, or H atoms, R¹ and R² not both simultaneously being H atoms. A and B are preferably sodium, potassium or ammonium ions, sodium ions being particularly preferred. Compounds I in which A and B are sodium ions, R¹ is a branched alkyl radical having 12 carbon atoms and R² is an H atom or R¹ are particularly advantageous. Industrial mixtures which have a proportion of from 50 to 90% by weight of the monoalkylated product are frequently used, for example Dowfax® 2A1 (brand of Dow Chemical Company). The compounds I are generally known, for example from U.S. Pat. No. 4,269,749, and are commercially available.

Nonionic and/or anionic emulsifiers are preferably used for the process according to the invention.

As a rule, the amount of additionally used dispersant, in particular emulsifiers, is from 0.1 to 5% by weight, preferably from 1 to 3% by weight, based in each case on the total amount of the monomer mixture M.

According to the invention, it is possible initially to take, if appropriate, a portion or the total amount of dispersant in the polymerization vessel. However, it is also possible to meter in the total amount or any remaining residual amount of dispersant during the polymerization reaction. The total amount or any remaining residual amount of dispersant can be metered into the polymerization vessel batchwise in one or more portions or continuously with constant or variable flow rates. Particularly advantageously, the metering of the dispersants during the polymerization reaction is effected continuously with constant flow rates, in particular as a constituent of an aqueous monomer emulsion.

The monomer mixture M used according to the invention is composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1.

Particularly suitable monomers M1 are glycidyl acrylate and/or glycidyl methacrylate and hydroxyalkyl acrylates and methacrylates having C₂- to C₁₀-hydroxyalkyl groups, in particular C₂- to C₄-hydroxyalkyl groups and preferably C₂- and C₃-hydroxyalkyl groups. 2-Hydroxyethyl acrylate, 2-hydroxyethyl methacrylate, 3-hydroxypropyl acrylate, 3-hydroxypropyl methacrylate, 4-hydroxybutyl acrylate and/or 4-hydroxybutyl methacrylate may be mentioned by way of example. Particularly advantageously, however, glycidyl acrylate and/or glycidyl methacrylate is used as monomer M1, glycidyl methacrylate being particularly preferred.

According to the invention, it is possible, if appropriate, initially to take a portion or the total amount of monomers M1 in the polymerization vessel. However, it is also possible to meter in the total amount or any remaining residual amount of monomers M1 during the polymerization reaction. The total amount or any remaining residual amount of monomers M1 can be metered into the polymerization vessel batchwise in one or more portions or continuously with constant or variable flow rates. Particularly advantageously, the metering of the monomers M1 during the polymerization reaction is effected continuously with constant flow rates, in particular as a constituent of an aqueous monomer emulsion.

In particular, ethylenically unsaturated compounds which can be subjected to free radical copolymerization in a simple manner with monomer M1, such as, for example, ethylene, vinyl aromatic monomers, such as styrene, α-methylstyrene, o-chlorostyrene or vinyltoluenes, vinyl halides, such as vinyl chloride or vinylidene chloride, esters of vinyl alcohol and monocarboxylic acids having 1 to 18 carbon atoms, such as vinyl acetate, vinyl propionate, vinyl n-butyrate, vinyl laurate and vinyl stearate, esters of α,β-monoethylenically unsaturated mono- and dicarboxylic acids having preferably 3 to 6 carbon atoms, such as, in particular, acrylic acid, methacrylic acid, maleic acid, fumaric acid and itaconic acid, with alkanols having in general 1 to 12, preferably 1 to 8 and in particular 1 to 4 carbon atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumurate and maleate, nitriles of α,β-monoethylenically unsaturated carboxylic acids, such as acrylonitrile, methacrylonitrile, fumarodinitrile, maleodinitrile, and C₄₋₈-conjugated dienes, such as 1,3-butadiene (butadiene) and isoprene, are suitable as at least one monomer M2 for the preparation of the aqueous polymer compositions according to the invention. Said monomers are as a rule the main monomers which, based on the total amount of monomers M2, together account for a proportion of ≧50% by weight, preferably ≧80% by weight and particularly ≧90% by weight. As a rule, these monomers have only a moderate to low solubility in water under standard temperature and pressure conditions [20° C., 1 atm (absolute)].

Monomers M2 which have a high water solubility under the abovementioned conditions are those which comprise either at least one acid group and/or the corresponding anion thereof or at least one amino, amido, ureido or n-heterocyclic group and/or the ammonium derivatives thereof which are alkylated or protonated on the nitrogen. α,β-monoethylenically unsaturated mono- and dicarboxylic acids having 3 to 6 carbon atoms and the amides thereof, such as, for example, acrylic acid, methacrylic acid, maleic acid, fumaric acid, itaconic acid, acrylamide and methacrylamide, and furthermore vinylsulfonic acid, 2-acrylamido-2-methylpropanesulfonic acid, styrenesulfonic acid and the water-soluble salts thereof and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate may be mentioned by way of example. Usually, the abovementioned water-soluble monomers M2 are present only as modifying monomers in amounts of ≦10% by weight, preferably ≦5% by weight and particularly preferably ≦3% by weight, based on the total amount of monomers M2.

Monomers M2, which usually increase the internal strength of the films of a polymer matrix, usually have at least one N-methylol or carbonyl group or at least two nonconjugated ethylenically unsaturated double bonds. Examples of these are monomers having two vinyl radicals, monomers having two vinylidene radicals and monomers having two alkenyl radicals. The diesters of dihydric alcohols with α,β-monoethylenically unsaturated monocarboxylic acids are particularly advantageous, and among these acrylic and methacrylic acid are preferred. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. In this context compounds such as diacetoneacrylamide and acetylacetoxyethyl acrylate or methacrylate are also of importance. Frequently, the abovementioned crosslinking monomers M2 are used in amounts of ≦10% by weight, preferably in amounts of ≦5% by weight and particularly preferably in amounts of ≦3% by weight, based in each case on the total amount of monomers A2. Frequently, however, no such crosslinking monomers M2 at all are used.

According to the invention those monomer mixtures which comprise
from 50 to 99.9% by weight of esters of acrylic and/or methacrylic acid with alkanols having 1 to 12 carbon atoms, or
from 50 to 99.9% by weight of styrene and/or butadiene, or
from 50 to 99.9% by weight of vinyl chloride and/or vinylidene chloride, or
from 40 to 99.9% by weight of vinyl acetate, vinyl propionate and/or ethylene
   are advantageously used as monomers M2.

According to the invention, those monomer mixtures which comprise
from 0.1 to 5% by weight of at least one α,β-monoethylenically unsaturated mono- and/or dicarboxylic acid having 3 to 6 carbon atoms and/or the amide thereof and
from 50 to 99.9% by weight of at least one ester of acrylic and/or methacrylic acid with alkanols having 1 to 12 carbon atoms, or
from 0.1 to 5% by weight of at least one α,β-monoethylenically unsaturated mono- and/or dicarboxylic acid having 3 to 6 carbon atoms and/or the amide thereof and
from 50 to 99.9% by weight of styrene and/or butadiene, or
from 0.1 to 5% by weight of at least one α,β-monoethylenically unsaturated mono- and/or dicarboxylic acid having 3 to 6 carbon atoms and/or the amide thereof and
from 50 to 99.9% by weight of vinyl chloride and/or vinylidene chloride, or
from 0.1 to 5% by weight of at least one α,β-monoethylenically unsaturated mono- and/or dicarboxylic acid having 3 to 6 carbon atoms and/or the amide thereof and
from 40 to 99.9% by weight of vinyl acetate, vinyl propionate and/or ethylene are particularly advantageously used as monomers M2.

According to the invention, it is possible, if appropriate, initially to take a portion or the total amount of monomers M2 in the polymerization vessel. However, it is also possible to meter in the total amount or any remaining residual amount of monomers M2 during the polymerization reaction. The total amount or any remaining residual amount of monomers M2 can be metered into the polymerization vessel batchwise in one or more portions or continuously with constant or variable flow rates. Particularly advantageously the metering of the monomers M2 during the polymerization reaction is effected continuously with constant flow rates, in particular as a constituent of an aqueous monomer emulsion.

Advantageously, the monomers M1 and M2 are used together as monomer mixture M in the form of an aqueous monomer emulsion.

According to the invention, advantageously used monomer mixtures M are those whose total content of monomers M1 is from 0.1% by weight to 5% by weight and in particular from 0.5% by weight to 3% by weight, and accordingly the total amount of monomers M2 is from 95% by weight to 99.9% by weight and in particular from 97% by weight to 99.5% by weight.

The free radical polymerization reaction is initiated by means of a free radical polymerization initiator familiar to the person skilled in the art for the aqueous emulsion polymerization (free radical initiator). Said initiators can in principle be both peroxides and azo compounds. Of course, redox initiator systems are also suitable. Peroxides which may be used are in principle inorganic peroxides, such as hydrogen peroxide, or peroxodisulfates, such as the mono- or di-alkali metal or ammonium salts of peroxodisulfuric acid, such as, for example, the mono- and disodium, mono- and dipotassium or ammonium salts thereof, or organic peroxides, such as alkyl hydroperoxides, for example tert-butyl, p-menthyl or cumyl hydroperoxide, and dialkyl or diaryl peroxides, such as di-tert-butyl or di-cumyl peroxide. 2,2′-Azobis(isobutyronitrile), 2,2″-azobis(2,4-dimethylvaleronitrile) and 2,2″-azobis(amidinopropyl) dihydrochloride (AIBA, corresponds to V-50 from Wako Chemicals) are substantially used as the azo compound. Suitable oxidizing agents for redox initiator systems are substantially the abovementioned peroxides. Sulfur compounds having a low oxidation state, such as alkali metal sulfites, for example potassium and/or sodium sulfite, alkali metal hydrogen sulfites for example potassium and/or sodium hydrogen sulfite, alkali metal metabisulfites, for example potassium and/or sodium metabisulfite, formaldehyde sulfoxylates, for example potassium and/or sodium formaldehyde sulfoxylate, alkali metal salts, especially potassium and/or sodium salts, of aliphatic sulfinic acids, and alkali metal hydrogen sulfides, such as, for example, potassium and/or sodium hydrogen sulfide, salts of polyvalent metals, such as iron(II) sulfate, iron(II) ammonium sulfate or iron(II) phosphate, enediols, such as dihydroxymaleic acid, benzoin and/or ascorbic acid, and reducing saccharides, such as sorbose, glucose, fructose and/or dihydroxyacetone, can be used as corresponding reducing agents. As a rule, the amount of the free radical initiator used, based on the total amount of monomer mixture M, is from 0.01 to 5% by weight, preferably from 0.1 to 3% by weight and particularly preferably from 0.2 to 1.5% by weight.

According to the invention, it is possible, if appropriate, initially to take a portion or the total amount of free radical initiator in the polymerization vessel. However, it is also possible to meter in the total amount or any remaining residual amount of free radical initiator during the polymerization reaction. The total amount or any remaining residual amount of free radical initiator can be metered into the polymerization vessel batchwise in one or more portions or continuously with constant or variable flow rates. Particularly advantageously, the metering of the free radical initiator during the polymerization reaction is effected continuously with constant flow rate—in particular in the form of an aqueous solution of the free radical initiator.

The polymerization reaction is effected under temperature and pressure conditions under which the free radical aqueous emulsion polymerization takes place at a sufficient polymerization rate; it is dependent in particular on the free radical initiator used. Advantageously, the type and amount of the free radical initiator, polymerization temperature and polymerization pressure are selected so that the free radical initiator has a half life of ≦3 hours, particularly advantageously ≦1 hour and very particularly advantageously ≦30 minutes.

Depending on the free radical initiator chosen, the total range of from 0 to 170° C. is suitable as a reaction temperature for the free radical polymerization reaction according to the invention of the monomer mixture M. As a rule, temperatures of from 50 to 120° C., in particular from 60 to 110° C. and advantageously from 70 to 100° C. are used. The free radical polymerization reaction according to the invention can be carried out at a pressure of less than, equal to or greater than 1 atm (1.01 bar absolute), so that the polymerization temperature may exceed 100° C. and may be up to 170° C. Preferably readily volatile monomers such as, for example, ethylene, butadiene or vinyl chloride are polymerized under superatmospheric pressure. The pressure may be 1.2, 1.5, 2, 5, 10 or 15 bar (absolute) or may assume even higher values. If polymerization reactions are carried out under reduced pressure, pressures of 950 mbar, frequently 900 mbar and often of 850 mbar (absolute) are established. Advantageously, the free radical polymerization according to the invention is carried out at 1 atm (absolute) under an inert gas atmosphere, such as, for example, under nitrogen or argon.

As a rule, the process according to the invention is advantageously effected in a manner such that at least a portion of the demineralized water used and, if appropriate, a portion of the free radical initiator, of the monomer mixture M and/or of the polymer A are initially taken in a polymerization vessel at from 20 to 25° C. (room temperature) and atmospheric pressure under an inert gas atmosphere, the initially taken mixture is then heated to the suitable polymerization temperature with stirring, and any remaining residual amount or the total amount of free radical initiator, monomer mixture M and/or polymer A is then metered into the polymerization mixture.

According to the invention, the ratio of polymer A to monomer mixture M (solid/solid) is advantageously from 10:90 to 90:10, particularly advantageously from 20:80 to 80:20 and particularly advantageously from 40:60 to 60:40.

The aqueous reaction medium can in principle also comprise small amounts of water-soluble organic solvents, such as, for example, methanol, ethanol, isopropanol, butanols, pentanols, but also acetone, etc. However, the process according to the invention is preferably carried out in the absence of such solvents.

By a specific variation of the type and amount of the monomers M1 and M2, it is possible, according to the invention, for the person skilled in the art to prepare aqueous polymer compositions whose polymers M have a glass transition temperature or a melting point in the range from −60 to 270° C. Glass transition temperature and melting point of the monomer M are to be understood in the context of this document as meaning that glass transition temperature or that melting point which the polymer obtained on polymerization of the monomer mixture M alone, i.e. polymerization in the absence of the polymer A, would have. According to the invention, the glass transition temperature of the polymer M is advantageously from ≧−20° C. to ≦105° C. and preferably from ≧20° C. to ≦100° C.

The glass transition temperature T_{g} means the limit of the glass transition temperature to which the glass transition temperature tends with increasing molecular weight, according to G. Kanig (Kolloid-Zeitschrift & Zeitschrift für Polymere, vol. 190, page 1, equation 1). The glass transition temperature or the melting point is determined by the DSC method (differential scanning calorimetry, 20 K/min, midpoint measurement, DIN 53765).

According to Fox (T. G. Fox, Bull. Am. Phys. Soc. 1956 [Ser. II] 1, page 123 and according to Ullmann's Encyclopädie der technischen Chemie, vol. 19, page 18, 4^{th} edition, Verlag Chemie, Weinheim, 1980) the following is a good approximation for the glass transition temperature of at most weakly crosslinked copolymers:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², T_{g}², . . . T_{g}ⁿ are the glass transition temperatures of the polymers composed in each case only of one of the monomers 1, 2, . . . n, in degrees kelvin. The T_{g} values for the homopolymers of most monomers are known and are mentioned, for example, in Ullmann's Encyclopedia of Industrial Chemistry, Part 5, Vol. A21, page 169, VCH Weinheim, 1992; other sources of glass transition temperatures of homopolymers are, for example, J. Brandrup, E. H. Immergut, Polymer Handbook, 1^{st} Ed., J. Wiley, New York 1966, 2^{nd} Ed. J. Wiley, New York 1975, and 3^{rd} Ed. J. Wiley, New York 1989).

The aqueous polymer compositions obtainable by the process according to the invention often comprise polymer compositions (corresponding to polymer A, polymer M and polymer A grafted with polymer M) whose minimum film formation temperature MFT is from ≧10° C. to ≦70° C., frequently from ≧20° C. to ≦60° C. or preferably from ≧25° C. to ≦50° C. Since the MFT is no longer measurable below 0° C., the lower limit of the MFT can be stated only by means of the T_{g} values. The MFT is determined according to DIN 53787.

The aqueous polymer compositions obtained according to the invention usually have polymer solids contents (sum of total amount of polymer A and total amount of monomer mixture M) of ≧10 and ≦70% by weight, frequently ≧20 and ≦65% by weight and often ≧40 and ≦60% by weight, based in each case on the aqueous polymer composition. The number average particle diameter determined by quasielastic light scattering (ISO standard 13321) (cumulant z-average) is as a rule from 10 to 2000 nm, frequently from 20 to 1000 nm and often from 50 to 700 nm or from 80 to 400 nm.

According to the invention, further optional assistants familiar to the person skilled in the art, such as, for example, so-called thickeners, antifoams, neutralizing agents, buffer substances, preservatives, free radical chain-transfer compounds and/or inorganic fillers, can also be used in the preparation of the aqueous polymer composition.

The aqueous polymer composition prepared by the abovementioned process is suitable in particular for impregnating base paper.

In the context of this document, base paper is to be understood as meaning a material which is sheet-like according to DIN 6730 (August 1985), substantially comprises fibers predominantly of vegetable origin and is formed by draining a fiber suspension comprising various assistants on a wire, the felt thus obtained then being compacted and dried. Assistants used are, for example, fillers, dyes, pigments, binders, optical brighteners, retention aids, wetting agents, antifoams, preservatives, slime control agents, plasticizers, antiblocking agents, antistatic agents, water repellants, etc. which are known to the person skilled in the art. Depending on the resulting basis weight of the sheet-like material obtained the term base paper (basis weight≦225 g/m²) or base board (basis weight≧225 g/m²) is also used. In addition, the term “cardboard” is also still customary and, with a basis weight of about 150 to 600 g/m², comprises both base paper varieties and base board varieties. For the sake of simplicity the term “base paper” below is to comprise base paper, base board and cardboard. Base paper differs from ready-to-use paper in that its surface has not been treated with a coating slip or has not been provided with printing ink or a protective coating.

For impregnating base paper, the aqueous polymer composition according to the invention is applied uniformly to at least one side of the base paper. The amount of aqueous polymer composition is chosen so that ≧1 g and ≦100 g, preferably ≧5 g and ≦50 g and particularly preferably ≧10 g and ≦30 g of polymer composition, calculated as solid, are applied per square meter of base paper. Particularly advantageously, the amount of aqueous polymer composition, calculated as solid, is such that the incorporation of polymer composition into the base paper is from 5 to 70% by weight, particularly advantageously from 10 to 60% by weight and especially advantageously from 15 to 50% by weight, based on the basis weight of the coated base paper. The incorporation (in %) is calculated as follows: amount of polymer composition (solid) per unit area of base paper×100/[amount of polymer composition (solid) per unit area of base paper+paper weight per unit area]. The application of the aqueous polymer composition to the base paper is familiar to the person skilled in the art and is effected, for example, by impregnating or by spraying the base paper.

After the application of the aqueous polymer composition the impregnated base paper is dried in a manner familiar to the person skilled in the art. Advantageously, drying is effected at a temperature which is higher than or equal to the glass transition temperature of the polymer M but is at least 70° C., advantageously at least 80° C. and particularly advantageously at least 100° C. The drying process is advantageously effected in a manner such that drying is continued until the coated base paper has a residual moisture content of ≦5% by weight, preferably ≦4% by weight and particularly preferably ≦3% by weight, based on the impregnated base paper. The residual moisture content is determined by first weighing the impregnated base paper at room temperature, then drying it for 2 minutes at 130° C. and then cooling it and weighing it again at room temperature. The residual moisture content corresponds to the weight difference between the impregnated base paper before and after the drying process, based on the weight of the impregnated base paper before the drying process, multiplied by the factor 100.

If the impregnated base paper (also referred to as “preimpregnated product”) is to be used for the production of decorative paper, the aqueous polymer composition can be applied only to one side or to both sides of the base paper. However, it is also possible to impregnate the base paper with the aqueous polymer composition. Advantageously, the aqueous polymer composition is applied to both sides of the base paper. The decorative papers obtainable from the preimpregnated product are used, for example, for the lamination of pieces of furniture or furniture parts.

The base papers impregnated by the process according to the invention have advantageous properties, in particular a substantially lower tendency to yellowing and a substantially improved tensile strength in the z direction in comparison with the impregnated base papers of the prior art.

The invention is to be explained in more detail with reference to the following nonlimiting examples.

### EXAMPLES

### A. Preparation of the Polymer A

235 g of isopropanol, 42 g of demineralized water and 12.7 g of a 50% strength by weight aqueous hydrogen peroxide solution were initially taken at room temperature under a nitrogen atmosphere in a 4 l four-necked flask equipped with an anchor stirrer, reflux condenser and two metering devices. Thereafter, the initially taken solution was heated to 85° C. with stirring and, beginning at the same time, feed 1 was metered in within 6 hours and feed 2 within 8 hours, continuously with constant flow rates. Thereafter, about 400 g of an isopropanol/water mixture were distilled off, 200 g of demineralized water were added and isopropanol/water was distilled off until a temperature of 100° C. was reached in the polymer solution. Thereafter, steam was passed through the aqueous polymer solution for about 1 hour while maintaining the temperature.

Feed 1 consisting of:

48.6 g of demineralized water
650 g of acrylic acid
276 g of isopropanol

Feed 2 consisting of:

25.9 g of a 50% strength by weight aqueous solution of hydrogen peroxide

The aqueous polymer solution thus obtained had a solids content of 50% by weight, a pH of 1.5 and a viscosity of 118 mPa·s. The weight average molecular weight determined by gel permeation chromatography was 6600 g/mol corresponding to a K value of 25.3.

The solids content was generally determined by drying a sample of about 1 g in a through-circulation drying oven for two hours at 120° C. In each case two separate measurements were carried out. The values stated in the examples are mean values of the two measured results.

The viscosity was generally determined using a Rheomat from Physica at a shear rate of 250 s⁻¹ according to DIN 53019 at 23° C.

The pH was determined using a Handylab 1 pH meter from Schott.

The K value of the polymer A was determined according to Fikentscher (ISO 1628-1).

The determination of the weight average molecular weight of the polymer A was effected by means of gel permeation chromatography (linear column: Supremea M from PSS, eluent: 0.08 mol/l TRIS buffer pH 7.0, demineralized water, liquid flow rate: 0.8 ml/min, detector: differential refractometer ERC 7510 from ERC).

The mean particle diameter of the polymer particles was determined by dynamic light scattering on a 0.005 to 0.01 percent by weight aqueous polymer dispersion at 23° C. by means of an Autosizer MC from Malvern Instruments, England. The mean diameter of the cumulant evaluation (cumulant z-average) of the measured autocorrelation function is stated (ISO standard 13321).

### B. Preparation of the Aqueous Polymer Compositions

### Example 1 (E1)

202 g of demineralized water, 750 g of the aqueous solution of polymer A and 18 g of a 50% strength by weight aqueous solution of sodium hydroxide were initially taken at room temperature under a nitrogen atmosphere in a 5 l four-necked flask equipped with an anchor stirrer, reflux condenser and two metering devices. Thereafter, the initially taken solution was heated to 90° C. with stirring and 10.7 g of feed 2 were added. After 5 minutes, beginning at the same time, feeds 1 and 3 and the residual amount of feed 2 were metered in continuously with constant flow rates within 2.5 hours.

Feed 1 consisting of:
375 g of demineralized water
26.8 g of a 28% strength by weight aqueous solution of a sodium lauryl ether sulfate (Texapon® NSO from Cognis)
22.5 g of glycidyl methacrylate
713 g of styrene
15.0 g of acrylic acid
25.0 g of sodium pyrophosphate

Feed 2 consisting of:
39.9 g of demineralized water
3.0 g of sodium persulfate

Feed 3 consisting of:
75.0 g of demineralized water
750 g of the aqueous solution of polymer A
18.0 g of a 50% strength by weight aqueous solution of sodium hydroxide

After the end of the feeds, the aqueous polymer composition was allowed to cool to 75° C. Thereafter beginning at the same time, 15.0 g of a 10% strength by weight aqueous solution of tert-butyl hydroperoxide and 18.3 g of a 13% strength by weight aqueous solution of acetone disulfite (molar reaction product of acetone with sodium hydrogen sulfite (NaHSO₃)) were added continuously with constant flow rates within 90 minutes to the aqueous polymer composition for removing residual monomers. The aqueous polymer composition E1 obtained was then cooled to room temperature. Thereafter, the aqueous polymer composition was filtered over a 125 μm net. About 0.01 g of coagulum was removed thereby.

The aqueous polymer composition E1 obtained had a pH of 3.1, a solids content of 49.9% by weight and a viscosity of 93 mPa·s. The mean particle size was determined as 204 nm.

### Example 2 (E2)

108 g of demineralized water, 400 g of the aqueous solution of polymer A and 9.6 g of a 50% strength by weight aqueous solution of sodium hydroxide were initially taken at room temperature under a nitrogen atmosphere in a 5 l four-necked flask equipped with an anchor stirrer, reflux condenser and two metering devices. Thereafter, the initially taken solution was heated to 90° C. with stirring and 5.7 g of feed 2 were added. After 5 minutes, beginning at the same time, feeds 1 and 3 and the residual amount of feed 2 were metered in continuously with constant flow rates within 2.5 hours.

Feed 1 consisting of:

200 g of demineralized water
14.3 g of a 28% strength by weight aqueous solution of Texapon® NSO
12.0 g of glycidyl methacrylate
208 g of styrene
172 g of n-butyl acrylate
15.0 g of acrylic acid
13.3 g of sodium pyrophosphate

Feed 2 consisting of:

21.3 g of demineralized water
1.6 g of sodium persulfate

Feed 3 consisting of:

40.0 g of demineralized water
1467 g of the aqueous solution of polymer A
35.2 g of a 50% strength by weight aqueous solution of sodium hydroxide

After the end of the feeds, the aqueous polymer composition was allowed to cool to 75° C. Thereafter beginning at the same time, 8.0 g of a 10% strength by weight aqueous solution of tert-butyl hydroperoxide and 9.7 g of a 13% strength by weight aqueous solution of acetone disulfite were added continuously with constant flow rates within 90 minutes to the aqueous polymer composition for removing residual monomers. The aqueous polymer composition E2 obtained was then cooled to room temperature. Thereafter, the aqueous polymer composition was filtered over a 125 μm net. About 0.2 g of coagulum was removed thereby.

The aqueous polymer composition E2 obtained had a pH of 3.1, a solids content of 49.5% by weight and a viscosity of 72 mPa·s. The mean particle size was determined as 230 nm.

### Comparative Example 1 (C1)

500 g of the aqueous solution of polymer A were homogeneously mixed with 75 g of triethanolamine with stirring.

### Comparative example 2 (C2)

175.6 g of demineralized water were initially taken at room temperature under a nitrogen atmosphere in a 2 l four-necked flask equipped with an anchor stirrer, reflux condenser and two metering devices. Thereafter, the initially taken substance was heated to 90° C. with stirring and first 63.5 g of feed 1 and then 5.7 g of feed 2 were added. After 5 minutes, beginning at the same time, the residual amounts of feeds 1 and 2 were metered in continuously with constant flow rates within 2.5 hours.

Feed 1 consisting of:

200 g of demineralized water
14.3 g of a 28% strength by weight aqueous solution of Texapon® NSO
12.0 g of glycidyl methacrylate
208 g of styrene
172 g of n-butyl acrylate
15.0 g of acrylic acid
13.3 g of sodium pyrophosphate

Feed 2 consisting of:

21.3 g of demineralized water
1.6 g of sodium persulfate

After the end of the feeds, the aqueous polymer composition was allowed to cool to 75° C. Thereafter beginning at the same time, 8.0 g of a 10% strength by weight aqueous solution of tert-butyl hydroperoxide and 9.7 g of a 13% strength by weight aqueous solution of acetone disulfite were added continuously with constant flow rates within 90 minutes to the aqueous polymer composition for removing residual monomers. The aqueous polymer composition C2 obtained was then cooled to room temperature. Thereafter, the aqueous polymer composition was filtered over a 125 μm net. About 0.5 g of coagulum was removed thereby.

The aqueous polymer composition C2 obtained had a pH of 2.1, a solids content of 50.3% by weight and a viscosity of 58 mPa·s. The mean particle size was determined as 195 nm.

### C. Investigations of Performance Characteristics

A base paper of DIN A4 format having a basis weight of 50 g/m² was used.

The aqueous polymer compositions E1 and E2 and C1 and C2 obtained in the examples and comparative examples were diluted to a solids content of 28% by weight with demineralized water. The base paper was then impregnated with the dilute aqueous polymer compositions in the longitudinal direction by means of a laboratory padding mangle in such a way that the base paper comprised 10 g of polymer composition, calculated as solid, per square meter. The paper sheets obtained were dried in a Mat this oven for 3 minutes in circulated air at 130° C. The paper sheets obtained depending on the polymer composition used are referred to below as impregnated papers E1, E2, C1 and C2.

### Yellowing Test

5 cm wide and 12 cm long strips were cut from the impregnated papers at room temperature, and these strips were heated to 210° C. in a drying oven for 30 seconds. After cooling to room temperature, the impregnated paper strips treated in this manner were measured in a Luci 100 colorimeter from Lange, in accordance with DIN 5033. The so-called b value is stated as a measure of the intensity of the yellowing; the higher the b value, the more intense is the yellowing of the impregnated paper. The results of the yellowing test are summarized in table 1.

### Determination of the Tensile Strength in the Z Direction

For carrying out this determination, 2×2 cm squares were cut from the impregnated papers and were stored for 24 hours in a conditioned chamber at 23° C. and 50% relative humidity. Thereafter, planar stainless steel dies having a circular, 113 mm² test area were stuck by means of an adhesive (Loctite® 401) on the top and bottom of these papers in coincidence, and the stainless steel dies were loaded with a weight of 1 kg in the perpendicular orientation at room temperature for four hours. Thereafter, the paper squares with the stainless steel dies stuck in coincidence on the top and bottom were introduced into a clamping apparatus, the upper and the lower die were fastened in the apparatus and the two dies were then drawn apart at a speed of 75 mm per minute in opposite directions and the resulting forces (in N/mm²) on cleavage of the impregnated paper were measured. The tensile strength of the impregnated papers is the better the higher the forces required for the cleavage. The results obtained in the tensile strength tests are likewise summarized in table 1.

TABLE 1
Summary of the results

| | Yellowing | Tensile strength |
|---|---|---|
| Impregnated paper | b value | N/mm² |
| E1 | 4.25 | 14.7 |
| E2 | 4.28 | 11.6 |
| C1 | 5.69 | 10.6 |
| C2 | 4.53 | 7.1 |

1. An aqueous polymer composition for impregnating base paper, the aqueous polymer composition being obtainable by free radical emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
from 0 to 20% by weight of at least one further ethylenically unsaturated monomer which differs from the monomers A1 [monomers A2], incorporated in the form of polymerized units,
and the monomer mixture M being composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1.

2. The aqueous polymer according to claim 1, the ratio of polymer A to monomer mixture M being from 10:90 to 90:10.

3. The aqueous polymer according to claim 1, polymer A being composed of 100% by weight of an ethylenically unsaturated monocarboxylic acid.

4. The aqueous polymer according to claim 1, exclusively acrylic acid being used as monomer A1.

5. The aqueous polymer according to claim 1, the polymer A having a weight average molecular weight of ≧3000 g/mol and ≦20 000 g/mol.

6. The aqueous polymer according to claim 1, the monomers M1 and M2 of the monomer mixture M being selected so that the polymer M obtained by polymerization of the monomer mixture M has a glass transition temperature of ≧−20° C. and ≦105° C.

7. The aqueous polymer according to claim 1, the monomer M1 being selected from glycidyl acrylate, glycidyl methacrylate, 2-hydroxyethyl acrylate, 2-hydroxyethyl methacrylate, 3-hydroxypropyl acrylate, 3-hydroxypropyl methacrylate, 4-hydroxybutyl acrylate and/or 4-hydroxybutyl methacrylate.

8. A process for impregnating base paper with an aqueous polymer composition, wherein an aqueous polymer composition which is obtainable by free radical emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
from 0 to 20% by weight of at least one further ethylenically unsaturated monomer which differs from the monomers A1 [monomers A2] incorporated in the form of polymerized units,
and the monomer mixture M being composed of
i) from 0.01 to 10% by weight of at least one ethylenically unsaturated monomer M1 which comprises at least one epoxide group and/or at least one hydroxyalkyl group, and
from 90 to 99.99% by weight of at least one further ethylenically unsaturated monomer M2 which differs from the monomers M1,
is applied to the base paper and then dried.

9. The process according to claim 8, wherein the monomers M1 and M2 of the monomer mixture M are selected so that the polymer M obtained by polymerization of the monomer mixture M has a glass transition temperature of ≧−20° C. and ≦105° C.

10. The process according to claim 8, wherein the amount of aqueous polymer composition is chosen so that ≧1 g and ≦100 g of polymer composition, calculated as solid, are applied per square meter of base paper.

11. The process according to claim 8, wherein the drying is effected at a temperature which is higher than or equal to the glass transition temperature of the polymer M but is at least 70° C.

12. The process according to claim 8, wherein the residual moisture content is ≦5% by weight, based on the coated base paper.

13. A base paper obtainable by a process according to claim 8.

14. The method of using a base paper according to claim 13 for the production of decorative paper.

15. A process for the preparation of an aqueous polymer composition by free radical emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
from 0 to 20% by weight of at least one further ethylenically unsaturated monomer which differs from the monomers A1 [monomers A2], incorporated in the form of polymerized units,
wherein the monomer mixture M is composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1.

16. The process according to claim 15, wherein the ratio of polymer A to monomer mixture M is from 10:90 to 90:10.

17. An aqueous polymer composition obtainable by a process according to claim 15.
